(19) United States
(12) Patent Application Publication
(10) Pub. No.: US 2017/0195585 A1
(43) Pub. Date: Jul. 6, 2017

(54) DUAL-SPECTRUM CAMERA MODULE

(71) Applicant: Cheng Uei Precision Industry Co., Ltd., New Taipei City (TW)

(72) Inventors: Yu Min Hsu, New Taipei City (TW); Chien Ming Shih, New Taipei City (TW)

(21) Appl. No.: 15/172,376

(22) Filed: Jun. 3, 2016

(30) Foreign Application Priority Data
Jan. 5, 2016 (TW) 105200056

(51) Int. Cl. H04N 5/33; H04N 9/083; H04N 5/225; H04N 9/04

(52) U.S. Cl. CPC H04N 5/332; H04N 9/045; H04N 9/083; H04N 5/2254

(57) ABSTRACT

A dual-spectrum camera module includes a circuit board, a lens holder mounted on the circuit board, a lens body mounted to an upper portion of the lens holder, a RGB-IR (Red, Green and Blue, Infrared) image sensor electrically mounted on the circuit board and located under the lens body, a first filter movably mounted in the lens holder, and a second filter movably mounted in the lens holder. A thickness of the second filter is smaller than a thickness of the first filter. A wave length of light passing from the second filter is greater than a wave length of light passing from the first filter. The second filter and the first filter are abreast with each other and capable of reciprocating laterally to make the first filter or the second filter be located between the lens body and the RGB-IR image sensor.

### CROSS-REFERENCE TO RELATED APPLICATION

The present application is based on, and claims priority form, Taiwan Patent Application No. 105200056, filed Jan. 5, 2016, the disclosure of which is hereby incorporated by reference herein in its entirety.

### BACKGROUND OF THE INVENTION

1. Field of the Invention

The present invention generally relates to a camera module, and more particularly to a dual-spectrum camera module.

2. The Related Art

A biological recognition technology is a technology according to an inherent human physiology characteristic or a behavior characteristic to proceed recognizing. Currently, a lot of biological recognition technologies are emerged, such as fingerprint recognition, palm geometry recognition, iris recognition, retina recognition, facial recognition, signature recognition, voice recognition etc.

The facial recognition is widely used in an access control system and other fields. The facial recognition is a non-contact recognition way. Just an original human face image is acquired, characteristic data are got to generate characteristic templates, and then in use, a current human face image is acquired again to compare with the original human face image so as to confirm whether the current human face image is the same as the original human face image. Currently, the facial recognition adopts active infrared light to acquire an infrared black-and-white picture to extract biological characteristics, especially, a facial recognition equipment includes terminals and dedicated biological recognition cameras of PC biological recognition systems. But the infrared black-and-white picture is without color to make an acceptability of a visual sense worse, so a current biological recognition equipment adopts dual cameras. A colorful camera acquires colorful image data (visible light) for being used in video output. A black-and-white camera acquires infrared black-and-white image data (infrared light) for a usage of the biological recognition technology.

The colorful camera includes a first circuit board, a RGB (Red, Green, Blue) image sensor mounted on the first circuit board, a first lens holder mounted to the first circuit board, a first lens body mounted to an upper portion of the first lens holder, and a first filter disposed to a top end of the first lens body. The first filter is used for cutting off the infrared light, and the visible light is still able to pass through the first filter. The black-and-white camera includes a second circuit board, an IR (infrared radiation) image sensor mounted on the second circuit board, a second lens holder mounted to the second circuit board, a second lens body mounted to an upper portion of the second lens holder, and a second filter disposed to a top end of the second lens body. The second filter is used for filtering the visible light, and the infrared light is able to pass through the second filter.

A drawback of the dual cameras applied in an equipment terminal is to need double camera costs, and occupy limited space of the equipment terminal, especially, the dual cameras are used in a portable mobile equipment terminal, such as an intelligent cell phone, a tablet computer, etc. In view of the equipment terminal being required lighter and thinner, the dual cameras become a major technical obstacle that affects the biological recognition technology to be applied in the portable mobile equipment terminal widely. In addition, an unavoidable position difference between the dual cameras results in a position difference between two acquired image contents, so a recognition effect is affected.

Thus, it is essential to provide an innovative camera module, the innovative camera module is a dual-spectrum camera module capable of being applied in a biological recognition equipment for shooting to output colorful images and proceeding biological recognition.

### SUMMARY OF THE INVENTION

An object of the present invention is to provide a dual-spectrum camera module. The dual-spectrum camera module includes a circuit board, a lens holder mounted on the circuit board, a lens body mounted to an upper portion of the lens holder, a RGB-IR (Red, Green and Blue, Infrared) image sensor, a first filter and a second filter. The RGB-IR image sensor is electrically mounted on the circuit board and located under the lens body. The first filter is movably mounted in the lens holder. The second filter is movably mounted in the lens holder. A thickness of the second filter is smaller than a thickness of the first filter. A wave length of light passing from the second filter is greater than a wave length of light passing from the first filter. The second filter and the first filter are abreast with each other and capable of reciprocating laterally to make the first filter or the second filter be located between the lens body and the RGB-IR image sensor.

As described above, the first filter and the second filter are movably mounted in the lens holder, the thickness of the second filter is smaller than the thickness of the first filter. The second filter and the first filter are abreast with each other and capable of reciprocating laterally to make the first filter or the second filter be located between the lens body and the RGB-IR image sensor. Furthermore, the dual-spectrum camera module is capable of switching between dual spectrums, and a focus of the back focal length of the dual-spectrum camera module when the first filter is located between the lens body and the RGB-IR image sensor and a focus of the back focal length of the dual-spectrum camera module when the second filter is located between the lens body and the RGB-IR image sensor are both disposed on the RGB-IR image sensor. As a result, the dual-spectrum camera module is capable of being applied in a biological recognition equipment for shooting to output colorful images and proceeding biological recognition.

### BRIEF DESCRIPTION OF THE DRAWINGS

The present invention will be apparent to those skilled in the art by reading the following description, with reference to the attached drawings, in which:

FIG. 1 is a sectional view of a dual-spectrum camera module in accordance with an embodiment of the present invention;

FIG. 2 is a perspective view of a first filter and a second filter of the dual-spectrum camera module of FIG. 1;

FIG. 3 is a graph of a relation between a transmittance and a wave length of the first filter of the dual-spectrum camera module of FIG. 2;

FIG. 4 is a graph of a relation between a transmittance and a wave length of the second filter of the dual-spectrum camera module of FIG. 2; and

FIG. 5 is a schematic diagram showing a relation between a thickness of a filter and a back focal length of the dual-spectrum camera module of FIG. 1.

### DETAILED DESCRIPTION OF THE PREFERRED EMBODIMENT

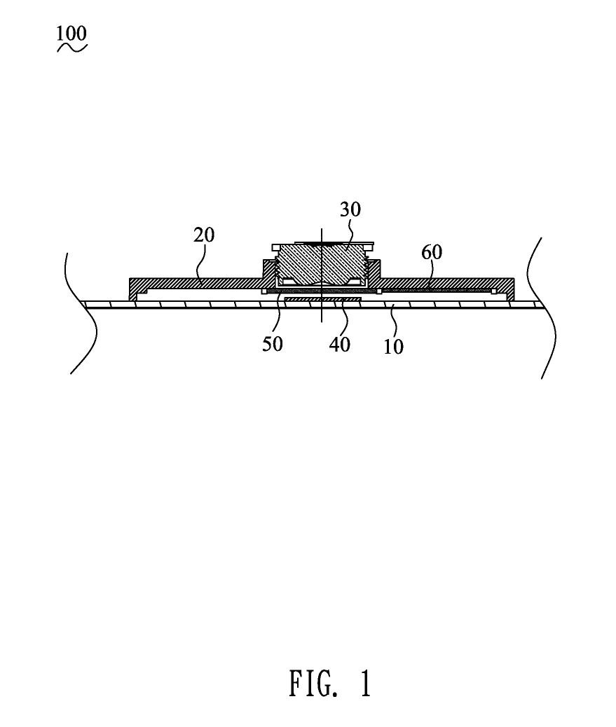

With reference to FIG. 1, a dual-spectrum camera module 100 in accordance with an embodiment of the present invention is shown. The camera module 100 includes a circuit board 10, a lens holder 20, a lens body 30, a RGB-IR (Red, Green and Blue, Infrared) image sensor 40, a first filter 50 and a second filter 60.

The lens holder 20 is mounted on the circuit board 10. The lens body 30 is mounted to an upper portion of the lens holder 20. The RGB-IR image sensor 40 is electrically mounted on the circuit board 10 and located under the lens body 30.

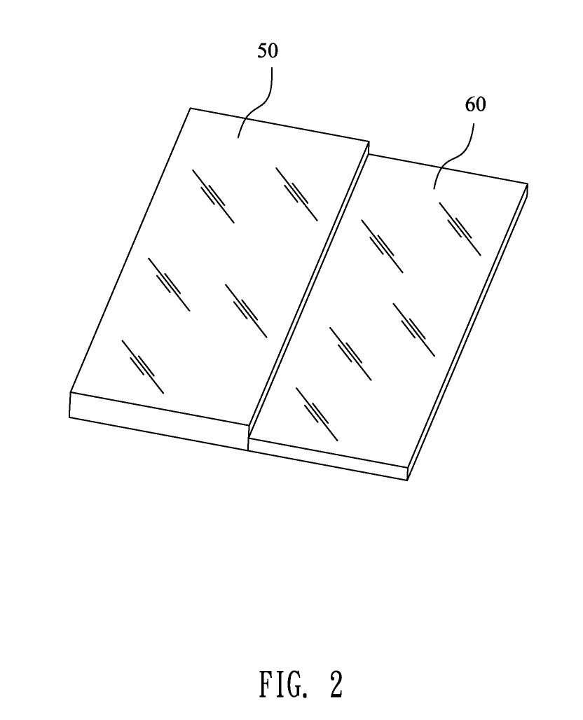

Referring to FIG. 1 and FIG. 2, the first filter 50 is movably mounted in the lens holder 20. The second filter 60 is movably mounted in the lens holder 20. A thickness of the second filter 60 is different from a thickness of the first filter 50. Specifically, the thickness of the second filter 60 is smaller than the thickness of the first filter 50. The second filter 60 and the first filter 50 are abreast with each other and capable of reciprocating laterally to make the first filter 50 or the second filter 60 be located between the lens body 30 and the RGB-IR image sensor 40. The second filter 60 is fastened to one side surface of the first filter 50.

Referring to FIG. 1 to FIG. 4, a wave length of light passing from the second filter 60 is greater than a wave length of light passing from the first filter 50. Specifically, the wave length of the light passing from the first filter 50 falls in an approximate range of 420 nm to 650 nm. The first filter 50 allows some visible light passing, and filters infrared light and other light. The wave length of the light passing from the second filter 60 is approximately 850 nm. The second filter 60 allows some infrared light passing, and filtering the visible light and other light. The dual-spectrum camera module 100 is capable of being applied in a biological recognition equipment for shooting to output colorful images and proceeding biological recognition. In use, the dual-spectrum camera module 100 is capable of switching between dual spectrums, so the dual-spectrum camera module 100 has better effects of outputting the colorful images and proceeding the biological recognition whenever in day or night.

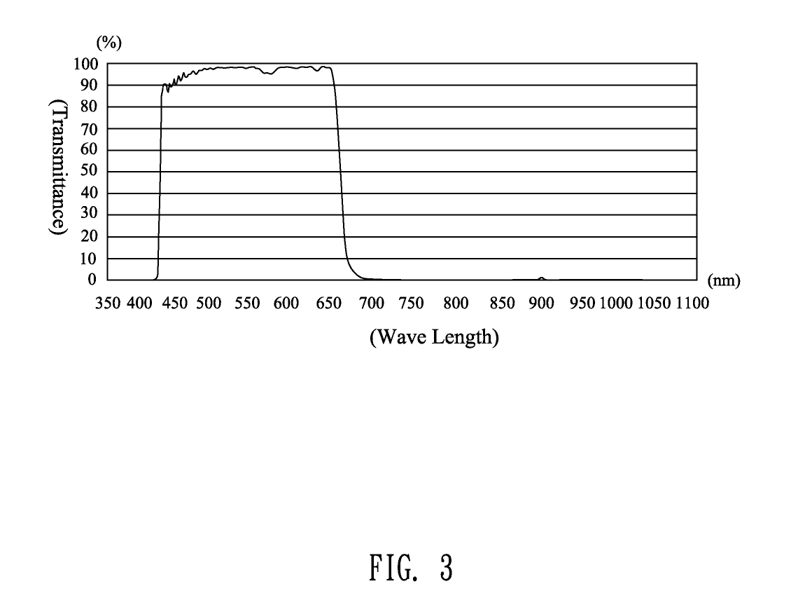

Referring to FIG. 2 and FIG. 3, a graph of a relation between a transmittance and the wave length of the first filter 50 of the dual-spectrum camera module 100 in accordance with the embodiment of the present invention is shown in FIG. 3. The thickness of the first filter 50 in accordance with the embodiment of the present invention is 0.21 mm.

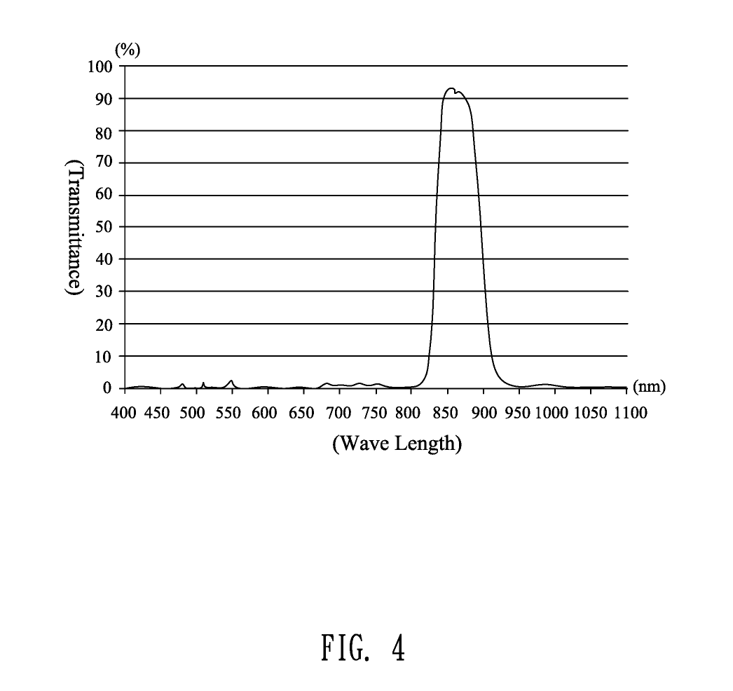

Referring to FIG. 2 and FIG. 4, a graph of a relation between a transmittance and the wave length of the second filter 60 of the dual-spectrum camera module 100 in accordance with the embodiment of the present invention is shown in FIG. 4. The thickness of the second filter 60 in accordance with the embodiment of the present invention is 0.16 mm.

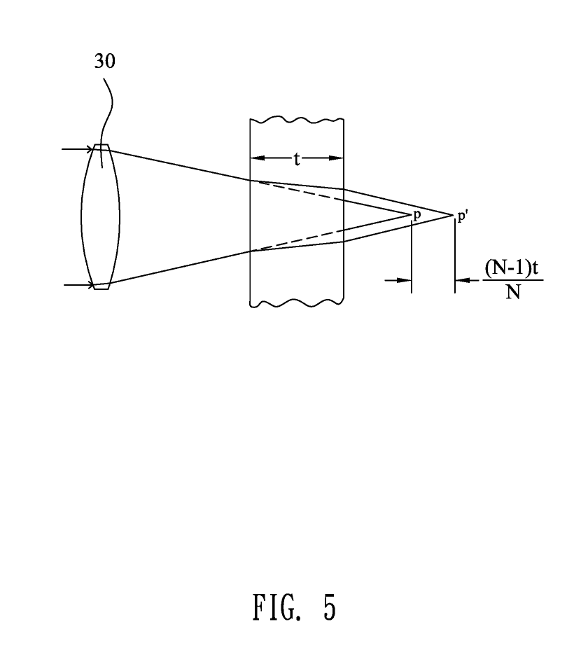

Referring to FIG. 1 and FIG. 5, FIG. 5 is a schematic diagram showing a light ray reflected by a face penetrating through the lens body 30, then passing through a filter to be refracted for focusing, and a relation between a thickness of the filter and a back focal length of the dual-spectrum camera module 100. As shown in FIG. 5, N is a refractive index, t is the thickness of the filter, P is a back focal length of the dual-spectrum camera module 100 when the filter is omitted, and P′ is a back focal length of the dual-spectrum camera module 100 when the filter is involved. Because the wave length of the infrared light is greater than the wave length of the visible light, under a condition of a total height of the dual-spectrum camera module 100 being constant, in order to make a focus of a back focal length of the dual-spectrum camera module 100 when the first filter 50 is located between the lens body 30 and the RGB-IR image sensor 40 and a focus of a back focal length of the dual-spectrum camera module 100 when the second filter 60 is located between the lens body 30 and the RGB-IR image sensor 40 are both disposed on the RGB-IR image sensor 40, the thickness of the second filter 60 is smaller than the first filter 50. Preferably, the back focal length of the dual-spectrum camera module 100 when the first filter 50 is moved to be located between the lens body 30 and the RGB-IR image sensor 40 is the same as the back focal length of the dual-spectrum camera module 100 when the second filter 60 is moved to be located between the lens body 30 and the RGB-IR image sensor 40.

As described above, the first filter 50 and the second filter 60 are movably mounted in the lens holder 20, the thickness of the second filter 60 is smaller than the thickness of the first filter 50. The second filter 60 and the first filter 50 are abreast with each other and capable of reciprocating laterally to make the first filter 50 or the second filter 60 be located between the lens body 30 and the RGB-IR image sensor 40. Furthermore, the dual-spectrum camera module 100 is capable of switching between the dual spectrums, and the focus of the back focal length of the dual-spectrum camera module 100 when the first filter 50 is located between the lens body 30 and the RGB-IR image sensor 40 and the focus of the back focal length of the dual-spectrum camera module 100 when the second filter 60 is located between the lens body 30 and the RGB-IR image sensor 40 are both disposed on the RGB-IR image sensor 40. As a result, the dual-spectrum camera module 100 is capable of being applied in the biological recognition equipment for shooting to output the colorful images and proceeding the biological recognition.

What is claimed is:

1. A dual-spectrum camera module, comprising:
a circuit board;
a lens holder mounted on the circuit board;
a lens body mounted to an upper portion of the lens holder;
a RGB-IR ((Red, Green and Blue, Infrared) image sensor electrically mounted on the circuit board and located under the lens body;
a first filter movably mounted in the lens holder; and
a second filter movably mounted in the lens holder, a thickness of the second filter being smaller than a thickness of the first filter, a wave length of light passing from the second filter being greater than a wave length of light passing from the first filter,
wherein the second filter and the first filter are abreast with each other and capable of reciprocating laterally to make the first filter or the second filter be located between the lens body and the RGB-IR image sensor.

2. The dual-spectrum camera module as claimed in claim 1, wherein the second filter is fastened to one side surface of the first filter.

3. The dual-spectrum camera module as claimed in claim 1, wherein the wave length of the light passing from the first filter falls in an approximate range of 420 nm to 650 nm.

4. The dual-spectrum camera module as claimed in claim 1, wherein the wave length of the light passing from the second filter is approximately 850 nm.
